(19) United States
(12) Patent Application Publication
(10) Pub. No.: US 2023/0132160 A1
(43) Pub. Date: Apr. 27, 2023

(54) CONTROL DEVICE AND CONTROL METHOD FOR INJECTION MOLDING MACHINE

(71) Applicant: FANUC CORPORATION, Minamitsuru-gun (JP)

(72) Inventors: Ryou OOSAKA, Minamitsuru-gun, Yamanashi-ken (JP); Atsushi HORIUCHI, Minamitsuru-gun, Yamanashi-ken (JP)

(21) Appl. No.: 17/914,682

(22) PCT Filed: Mar. 22, 2021
(86) PCT No.: PCT/JP2021/011563

§ 371 Date: Sep. 26, 2022

(30) Foreign Application Priority Data
Mar. 27, 2020 (JP) 2020-057529

(51) Int. Cl. B29C 45/80; B29C 45/14; B29C 45/26

(52) U.S. Cl. CPC B29C 45/80; B29C 45/14008; B29C 45/2628; B29C 2945/76167; B29C 2945/76568; B29C 2945/76294; B29C 2945/76357; B29C 2945/76866; B29C 2945/76872

(57) ABSTRACT

Provided are a control device and a control method for an injection molding machine that carries out a punching step with high reliability. A control device for an injection molding machine, the control device being equipped with: a mold opening/closing unit that integrally moves a fixed mold and a moving mold of a mold of the injection molding machine in the opening direction from a state where the mold is closed, thereby creating a gap between the fixed mold and a mounting plate; an insertion member control unit for inserting an insertion member into the gap; an assessment unit for assessing whether the insertion member has been inserted into the gap; and a push control unit for pushing out a punching pin when the insertion member has been assessed to have been inserted into the gap.

### TECHNICAL FIELD

The present invention relates to a control device and a control method for an injection molding machine.

### BACKGROUND ART

In the field of injection molding machines, a technique is known in which a pin is inserted into a cavity of a closed mold, thereby forming a hole in a resin (a molded product) that is filled in the cavity. An example thereof is disclosed, for example, in JP H03-284920 A.

### SUMMARY OF THE INVENTION

Hereinafter, the process of forming the hole by inserting the pin into the resin inside the mold may also be referred to as a “punching step”. The punching step is performed by pushing out the pin from a side of the movable mold to a side of the fixed mold while maintaining the formation of the cavity, or more specifically, while the connection between the fixed mold and the movable mold is maintained.

In this instance, if a force that pushes out the pin exceeds a force for connecting the fixed mold and the movable mold, the mold will disadvantageously be opened at a time when the pin is pushed out. As a result, in the punching step, it is not possible to form the hole in the molded product.

Thus, the present invention has the object of providing a control device and a control method for an injection molding machine which carry out a punching step with high reliability.

One aspect of the invention is characterized by a control device for an injection molding machine, the injection molding machine including a mold, the mold including a fixed mold in which a first insert hole is provided and a movable mold configured to form a cavity together with the fixed mold, the mold being configured to be opened and closed by causing the fixed mold and the movable mold to separate away from and come into contact with each other, wherein the injection molding machine further includes a movable platen configured to support the movable mold, and configured to move along an opening/closing direction of the mold and thereby cause the movable mold to separate away from and come into contact with the fixed mold, a stationary platen configured to support the fixed mold, a parting lock configured to connect the fixed mold and the movable mold at a time when the movable platen moves in a closing direction of the mold, and to release the connection at a time when the mold is opened, a mounting plate configured to mount the fixed mold on the stationary platen, a punching pin that, in order to form a molded product including at least one of a hole or a cutout portion therein, is configured to be pushed out in a manner so as to punch out a portion of a resin inside the cavity toward the mounting plate via the first insert hole, and an insertion member configured to be inserted between the fixed mold and the mounting plate, and wherein the control device includes a mold opening/closing unit that, by causing the fixed mold to move integrally with the movable mold in an opening direction of the mold from a state in which the mold is closed, is configured to create a gap between the fixed mold and the mounting plate, an insertion member control unit configured to insert the insertion member into the gap, a determination unit configured to determine whether or not the insertion member has been inserted into the gap, and a pushing out control unit configured to push out the punching pin in a case that it is determined that the insertion member has been inserted into the gap.

Another aspect of the invention is characterized by a control method for an injection molding machine, the injection molding machine including a mold, the mold including a fixed mold in which a first insert hole is provided and a movable mold configured to form a cavity together with the fixed mold, the mold being configured to be opened and closed by causing the fixed mold and the movable mold to separate away from and come into contact with each other, wherein the injection molding machine further includes a movable platen configured to support the movable mold, and configured to move along an opening/closing direction of the mold and thereby cause the movable mold to separate away from and come into contact with the fixed mold, a stationary platen configured to support the fixed mold, a parting lock configured to connect the fixed mold and the movable mold at a time when the movable platen moves in a closing direction of the mold, and to release the connection at a time when the mold is opened, a mounting plate configured to mount the fixed mold on the stationary platen, a punching pin that, in order to form a molded product including at least one of a hole or a cutout portion therein, is configured to be pushed out in a manner so as to punch out a portion of a resin inside the cavity toward the mounting plate via the first insert hole, and an insertion member configured to be inserted between the fixed mold and the mounting plate, and wherein the control method includes a gap opening step of creating a gap between the fixed mold and the mounting plate, by causing the fixed mold to move integrally with the movable mold in an opening direction of the mold from a state in which the mold is closed, an insertion control step of inserting the insertion member into the gap, an insertion determination step of determining whether or not the insertion member has been inserted into the gap, and a punching step of pushing out the punching pin in a case that it is determined that the insertion member has been inserted into the gap.

According to the present invention, the control device and the control method for an injection molding machine are provided, which carry out the punching step with high reliability.

### BRIEF DESCRIPTION OF THE DRAWINGS

FIG. 1 is a schematic configuration diagram of an injection molding machine according to an embodiment of the present invention;

FIG. 2 is a first cross-sectional view schematically showing the configuration of a mold and a pushing out mechanism;

FIG. 3 is a cross-sectional view in order to describe a structure relating to an insert member provided in a fixed mold, and a first insert hole of the fixed mold;

FIG. 4 is a second cross-sectional view schematically showing the configuration of the mold and the pushing out mechanism;

FIG. 5A shows a first exemplary configuration of a slide plate;

FIG. 5B shows a second exemplary configuration of the slide plate;

FIG. 5C is a cross-sectional view taken along line VC-VC of FIG. 5A;

FIG. 6 is a schematic configuration diagram showing a control device of the injection molding machine according to the embodiment;

FIG. 7 is a flowchart showing a process flow of a control method for the injection molding machine according to the embodiment;

FIG. 8 is a first diagram in order to describe a gap opening step;

FIG. 9 is a second diagram in order to describe the gap opening step;

FIG. 10 is a time chart illustrating each of respective control states of a slide plate, an ejector plate, and a movable platen according to the control method;

FIG. 11 is a first diagram in order to describe an insertion control step;

FIG. 12 is a second diagram in order to describe the insertion control step;

FIG. 13 is a first diagram in order to describe a punching step;

FIG. 14 is a second diagram in order to describe the punching step;

FIG. 15 is a first diagram in order to describe a mold opening step and a pulling out control step;

FIG. 16A is a second diagram in order to describe the mold opening step and the pulling out control step;

FIG. 16B is a third diagram in order to describe the mold opening step and the pulling out control step;

FIG. 17 is a diagram in order to describe a pushing out step;

FIG. 18 is a configuration diagram in order to describe an insertion member according to an Exemplary Modification 3;

FIG. 19 is a diagram showing a state in which insertion members according to Exemplary Modification 3 are inserted into a gap;

FIG. 20 is a diagram in order to describe a punching step according to Exemplary Modification 3; and

FIG. 21 is a fourth exemplary configuration of the slide plate.

### DESCRIPTION OF THE INVENTION

Hereinafter, a control device and a control method for an injection molding machine according to the present invention will be presented and described in detail below with reference to preferred embodiments thereof.

### Embodiments

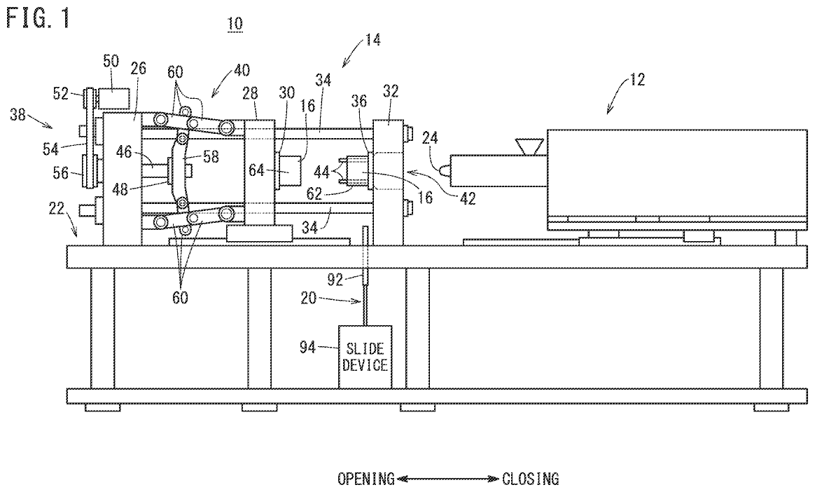

FIG. 1 is a configuration diagram of an injection molding machine 10 according to an embodiment of the present invention.

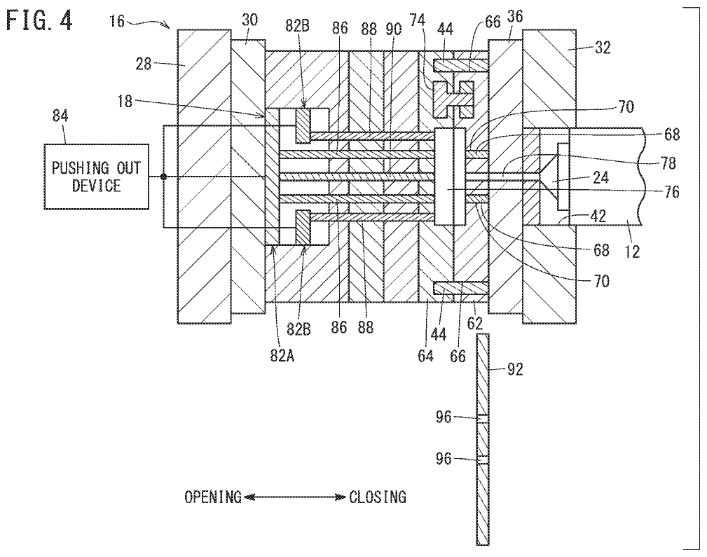

At first, a description will be given concerning an overall configuration of the injection molding machine 10. The injection molding machine 10 is equipped with an injection device 12, a mold clamping device 14, a mold 16, a pushing out mechanism 18 (see FIG. 4), and a slide mechanism 20. Further, a machine base 22 that supports at least one of the injection device 12 or the mold clamping device 14 (both are supported in the exemplary configuration shown in FIG. 1) is further provided.

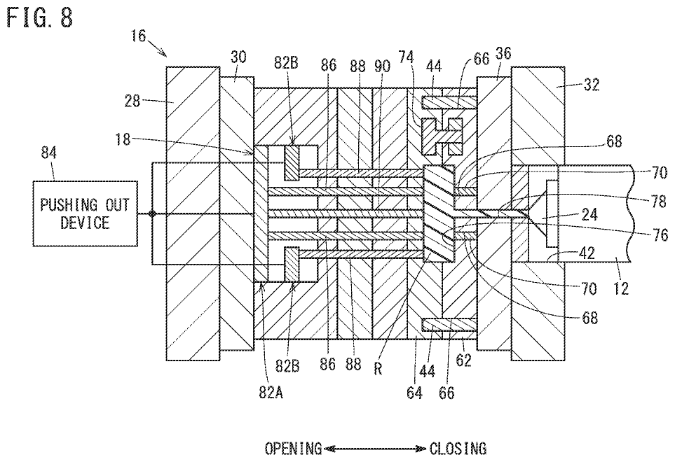

The injection device 12 is a device that performs melting and metering on the resin R, and thereafter, ejects the molten resin R (see FIG. 8) toward the mold 16 from a nozzle 24. Although FIG. 1 illustrates a so-called in-line screw type injection device 12, the configuration of the injection molding machine 10 of the present embodiment is not limited thereto. Instead of the in-line screw type injection device 12, the injection molding machine 10 may be equipped, for example, with a pre-plasticizing type injection device.

Moreover, in the present embodiment, melting, metering, and injection of the resin R may be realized on the basis of well-known techniques. Accordingly, hereinafter, a detailed description of such melting, metering, and injection of the resin R will be omitted.

The mold clamping device 14 is a device which, in addition to opening and closing the mold 16, applies a mold clamping force to the closed mold 16. In the present embodiment, the mold clamping device 14 will be described as one having a so-called toggle type configuration. However, insofar as opening and closing of the mold 16 and application of the mold clamping force can be achieved, the configuration of the mold clamping device 14 is not necessarily limited to this feature.

The mold clamping device 14 is equipped with a rear platen 26, a movable platen 28, a movable side mounting plate 30, a stationary platen 32, a plurality of tie bars 34, a fixed side mounting plate 36, a ball screw mechanism 38, and a toggle mechanism 40.

From among the rear platen 26, the movable platen 28, and the stationary platen 32, the rear platen 26 is arranged farthest away from the injection device 12 in the opening direction of the mold 16 (see FIG. 1), and the stationary platen 32 is arranged nearest to the injection device 12. The rear platen 26 and the stationary platen 32 are connected to each other by the plurality of tie bars 34. The movable platen 28 is arranged between the rear platen 26 and the stationary platen 32 in the opening/closing direction, and the plurality of tie bars 34 that connect the rear platen 26 and the stationary platen 32 are inserted through the movable platen.

On the movable platen 28, the movable side mounting plate 30 is attached to a surface facing the stationary platen 32. The movable side mounting plate 30 is a member that serves to retain a movable mold 64 of the mold 16, which will be described later.

A receiving member 42 in which the nozzle 24 of the injection device 12 is received is provided in the stationary platen 32, and the fixed side mounting plate 36 is provided on a portion of the receiving member 42 that faces the movable platen 28.

The fixed side mounting plate 36 is a member that serves to retain a fixed mold 62 of the mold 16, which will be described later. A plurality of guide pins 44 that project out along the opening/closing direction are provided on a surface of the fixed mold 62 that faces the movable platen 28. Further, one portion of a flow path 78 (see FIG. 4) for the resin R that is injected by the injection device 12 is provided on the fixed side mounting plate 36. Moreover, in the following, when the term “mounting plate” is simply used, unless otherwise specified in particular, the term refers to the fixed side mounting plate 36.

The ball screw mechanism 38 is connected to the rear platen 26 and the toggle mechanism 40. The ball screw mechanism 38 is equipped with a screw shaft 46 that rotates about an axial direction which is in parallel with the opening/closing direction, and a nut 48 that moves linearly along the screw shaft 46 when the screw shaft 46 is rotated. Further, a servomotor 50, a drive pulley 52, a belt 54, and a driven pulley 56 are further provided.

Among these elements, the drive pulley 52 is a pulley connected to a rotary shaft of the servomotor 50, and rotates integrally with the rotary shaft. The belt 54 is wound around the drive pulley 52 and the driven pulley 56, and transmits a rotational force generated by the servomotor 50 to the driven pulley 56 via the drive pulley 52 and itself. The driven pulley 56 is a pulley that is rotatably provided integrally with the screw shaft 46, and due to the rotational force of the servomotor 50, causes the screw shaft 46 to rotate.

Further, the toggle mechanism 40 is connected to the movable platen 28. The toggle mechanism 40 is equipped with a crosshead 58 provided integrally in a linearly movable manner with the nut 48, and a plurality of toggle links 60 that transmit a linearly moving force from the crosshead 58 to the movable platen 28.

In accordance with the above-described configuration of the mold clamping device 14, by driving the servomotor 50, the movable platen 28 is capable of being made to move along the opening/closing direction.

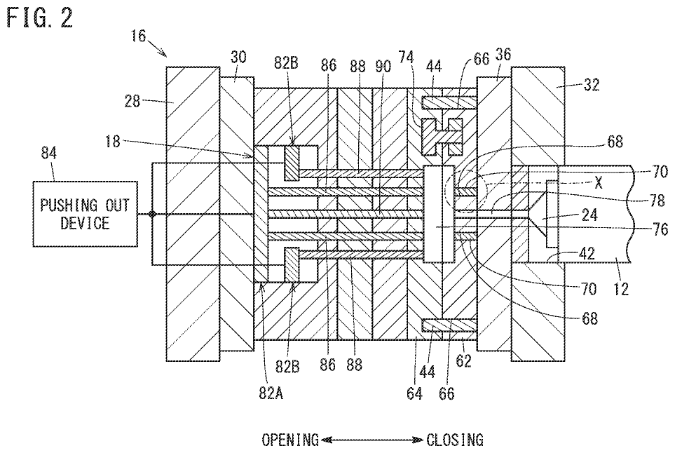

FIG. 2 is a first cross-sectional view schematically showing the configuration of the mold 16 and the pushing out mechanism 18.

The mold 16 serves to shape the resin R injected by the injection device 12 into the shape of the molded product, and is disposed between the movable platen 28 and the stationary platen 32. The mold 16 is equipped with the fixed mold 62 on the side of the stationary platen 32, and the movable mold 64 on the side of the movable platen 28.

According to the present embodiment, the fixed mold 62 is a female mold of the mold 16. Guide holes 66 corresponding to the number and arrangement of guide pins 44 are provided in the fixed mold 62. By the guide pins 44 of the mounting plate 36 being inserted into the guide holes 66, the fixed mold 62 is retained by the mounting plate 36. In accordance with this configuration, the fixed mold 62 moves along the guide pins 44, whereby the fixed mold is capable of being separated away from and brought into contact with the mounting plate 36 in the opening/closing direction.

Further, first insert holes 68 that penetrate through the fixed mold 62 in the opening/closing direction are provided in the fixed mold 62. The insert members 70 are inserted through the first insert holes 68.

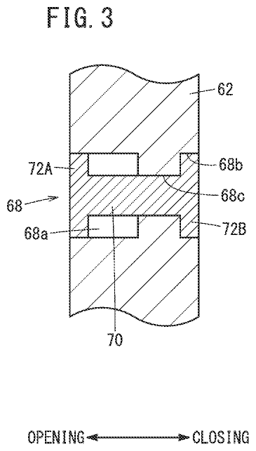

FIG. 3 is a cross-sectional view in order to describe the insert members 70 and the first insert holes 68. It should be noted that FIG. 3 is an enlarged view of the dashed line region (X) shown in FIG. 2.

The insert members 70 that are inserted into the first insert holes 68 can be slidably moved in the first insert holes 68 along the opening/closing direction. Stoppers 72A and stoppers 72B are provided at both ends of the insert members 70.

The stoppers 72A are stoppers that are accommodated in an opening direction side 68a of the first insert holes 68. In this instance, the stoppers 72A and the opening direction side 68a of the first insert holes 68 are wider than central portions 68c of the first insert holes 68. In accordance therewith, the insert members 70 are prevented from falling out toward a side in the closing direction of the first insert holes 68.

Further, the shape of the stoppers 72A is a shape that closes the first insert holes 68 when viewed from the opening direction side. In accordance therewith, at a time when the resin R is filled in the mold 16, the resin R is prevented from entering into the first insert holes 68.

The stoppers 72B are stoppers that are accommodated in a closing direction side 68b of the first insert holes 68. In this instance, the stoppers 72B and the closing direction sides 68b of the first insert holes 68 are wider than the central portions 68c of the first insert holes 68. In accordance therewith, the insert members 70 are prevented from falling out toward a side in the opening direction of the first insert holes 68.

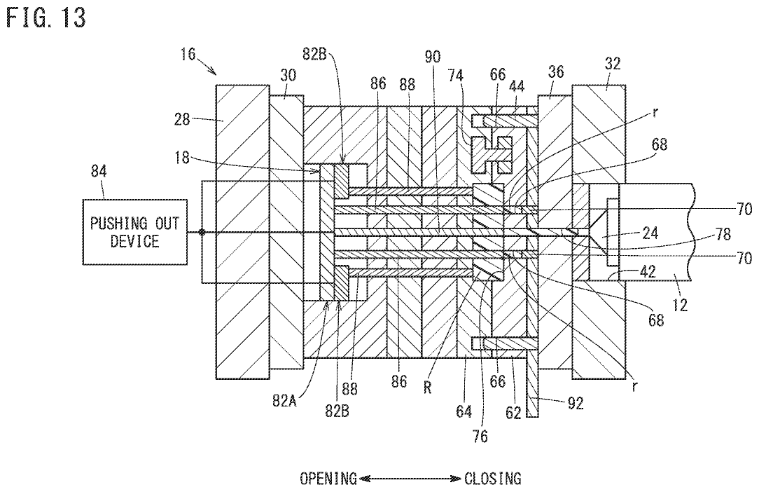

By providing the aforementioned first insert holes 68 in the fixed mold 62, at a time when the resin R is punched out by later-described punching pins 86, a portion r of the punched out resin R (see FIG. 13) can be pushed out into the first insert holes 68. Further, by inserting the insert members 70 that are slidably moved through the first insert holes 68, at a point in time prior to carrying out punching, it is possible to prevent the resin R from entering into the first insert holes 68. Accordingly, it is possible to prevent a shape (an unintended shape) of the first insert holes 68 from appearing in a portion of the shape of the molded product.

According to the present embodiment, the movable mold 64 is a male mold of the mold 16. By being moved in the opening/closing direction accompanying movement of the movable platen 28 in the opening/closing direction, the movable mold 64 separates away from and comes into contact with the fixed mold 62.

Further, holes in which the guide pins 44 that have been inserted through the fixed mold 62 are inserted are provided as appropriate in the movable mold 64. Owing thereto, in the mold closing step, a situation is prevented in which the guide pins 44 hinders the movable mold 64 and the fixed mold 62 from being pressed against each other while making contact with each other in the opening/closing direction.

In addition, in the mold 16, a parting lock 74 is provided that connects the fixed mold 62 and the movable mold 64 with a predetermined connection force. According to the present embodiment, the parting lock 74 is a spring lock type of parting lock. However, the parting lock 74 is not limited to being a spring lock type, and for example, may be a plastic lock type of parting lock.

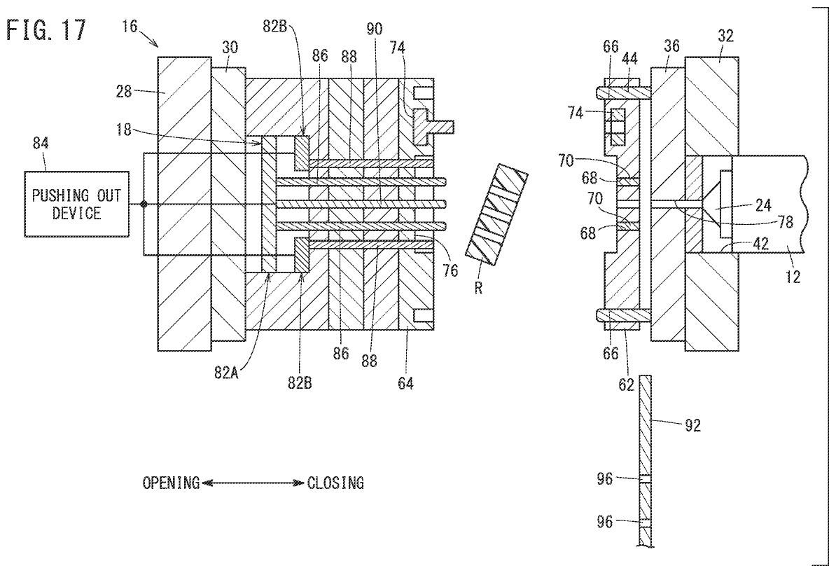

Concerning the above-described mold 16, when the mold 16 is “closed”, this implies that the fixed mold 62 and the movable mold 64 are pressed into contact with each other in the opening/closing direction (see FIG. 4). Further, when the mold 16 is “opened”, this implies that the fixed mold 62 and the movable mold 64 are separated away from each other in the opening/closing direction (see FIG. 17). The process step of closing the mold 16 is also referred to as a “mold closing step”, and the process step of opening the mold 16 is also referred to as a “mold opening step”.

By closing the mold 16, a cavity 76 is formed between the movable mold 64 and the fixed mold 62. The cavity 76 indicates a hollow vacancy according to the present embodiment.

The resin R injected from the injection device 12 passes through the flow path 78 (a sprue, a runner, and a gate) provided in the fixed mold 62 and the mounting plate 36, and is filled in the cavity 76. The resin R that is filled in the cavity 76 is cooled, and thereby solidifies into a state in which a contour of the molded product has been obtained. The process step of cooling the filled resin R is also referred to as a “cooling step”.

The closed state of the mold 16 is maintained by connecting the movable mold 64 and the fixed mold 62 together with the parting lock 74, and by the mold clamping device 14 applying the mold clamping force from the movable mold 64 side. In particular, the process step of applying the mold clamping force by the mold clamping device 14 is also referred to as a “mold clamping step”.

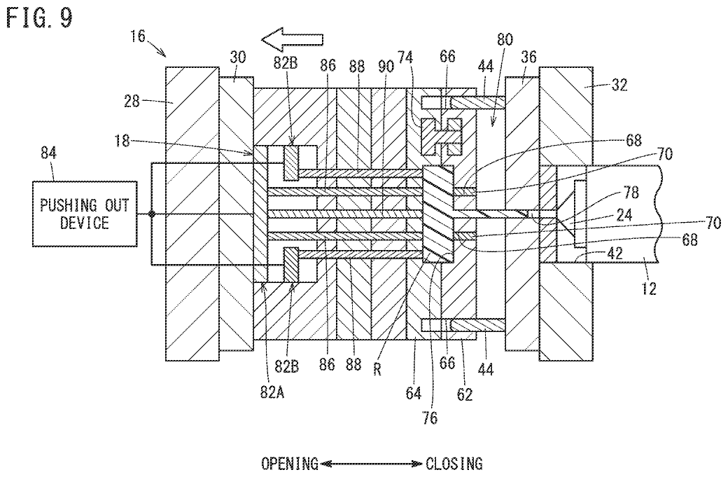

Moreover, as noted previously, the fixed mold 62 can be separated away from the mounting plate 36 in the opening direction. Accordingly, when the mold 16 is in the closed state, in the case that the movable platen 28 is pulled in the opening direction with a force that is lower than the connection force of the parting lock 74, a gap 80 (see FIG. 9) can be created between the fixed mold 62 and the mounting plate 36 with the closed state of the mold 16 being maintained. An insertion member 92, which will be described later, is inserted into and removed from the gap 80.

The pushing out mechanism 18 is a mechanism equipped with ejector plates 82A and 82B, a plurality of projecting members (86, 88, 90), and a pushing out device 84. The ejector plates 82A and 82B are plates that are provided on the movable mold 64 side, from among the fixed mold 62 side and the movable mold 64 side. The ejector plate 82A and the ejector plates 82B are provided so as to be shifted in position in the opening/closing direction, and the ejector plates 82B are located closer to the fixed mold 62 than the ejector plate 82A.

Among the devices described above, the pushing out device 84 is a device that causes the ejector plates 82A and 82B to move in a linear manner along a pushing out direction parallel to the opening/closing direction. Such a pushing out device 84 is capable of causing the ejector plates 82A and 82B to move in a linear manner, for example, by having a ball screw mechanism, a hydraulic or a pneumatic cylinder, or a servomotor.

The plurality of projecting members of the pushing out mechanism 18 include the punching pins 86 provided on the ejector plate 82A, ejector pins 88 provided on the ejector plates 82B, and a cutter 90 provided on the ejector plate 82A. Hereinafter, movement of the projecting members toward the fixed mold 62 in the pushing out direction may also be simply referred to as “pushing out”.

The punching pins 86 are pin members that serve to punch out a portion r of the resin R that is filled in the cavity 76. The punching pins 86 carry out punching by the ejector plate 82A being moved toward the fixed mold 62. Consequently, a molded product having holes is easily molded. The process of punching holes in the molded product with the punching pins 86 may also be referred to as a “punching process”, and is performed in a state in which the mold 16 is closed.

The punching pins 86 are provided face-to-face with the first insert holes 68 provided in the fixed mold 62 in the pushing out direction. Owing thereto, the punched out portion of the resin R is pushed out toward the first insert hole 68, which lies in front of the punching pin 86 in the pushing out direction. At this time, accompanying the pushing out thereof, the insert member 70 that is inserted in the first insert hole 68 moves toward the fixed side mounting plate 36.

Among the projecting members, the ejector pins 88 are pin members that push out the resin R (the molded product) that has solidified inside the cavity 76, at a time when the mold 16 is in an open state. Since the ejector pins 88 are provided on the ejector plate 82B, even if the ejector plate 82A undergoes movement in the punching step, the ejector pins 88 do not move, and do not penetrate through the resin R inside the cavity 76. By the ejector plate 82B, which is driven by the pushing out device 84, undergoing movement toward the fixed mold 62, the ejector pins 88 advance together with the ejector plate 82B and push out the molded product that is formed inside the cavity 76.

The process step of pushing out the molded product with the ejector pins 88 may also be referred to as a “pushing out step”. By performing the pushing out step, the molded product is easily taken out from the mold 16.

The cutter 90, without being pushed out toward the cavity 76, is pushed out toward the gate of the flow path 78 of the resin R. In the same manner as in the punching step, the cutter 90, by being pushed out when the mold 16 is in a state of being closed, is capable of cutting the molded product (i.e., the resin R in the cavity 76), and the resin R other than the molded product (the resin R in the gate, the runner, and the sprue). This type of cutting may also be referred to as “gate cutting”, and the step of performing gate cutting may also be referred to as a “gate cutting step”. Since both the punching step and the gate cutting step are performed in a state in which the mold 16 is closed, the steps can be performed in parallel.

The slide mechanism 20 is equipped with the insertion member 92 and a slide device 94 (see FIG. 1). Among these elements, according to the present embodiment, the insertion member 92 is a plate-shaped member provided in a manner so that a thickness direction thereof is parallel to the pushing out direction. According to the present embodiment, the plate-shaped insertion member 92 may also be referred to as a slide plate 92. It should be noted that the insertion member 92 is not limited to being a plate-shaped member (a slide plate). A description will be given later in an exemplary modification concerning this feature.

Further, the slide device 94 is a device for inserting and removing the slide plate 92 into and from the gap 80, which exists between the fixed mold 62 and the mounting plate 36, and which is created by causing the fixed mold 62 to move integrally with the movable mold 64 in the opening direction.

The slide device 94 according to the present embodiment serves to realize the aforementioned insertion and removal, by reciprocating the slide plate 92 in a linear manner between a predetermined insertion starting position (a pulling out completion position) and a predetermined insertion completion position in an insertion/removal direction perpendicular to the pushing out direction. Such a slide device 94 may cause the slide plate 92 to undergo linear movement by having a ball screw mechanism in the same manner as in the aforementioned mold clamping device 14, or may cause the slide plate 92 to undergo linear movement by having a hydraulic or a pneumatic cylinder.

FIG. 4 is a second cross-sectional view schematically showing the configuration of the mold 16 and the pushing out mechanism 18.

According to the present embodiment, the predetermined insertion starting position is set below the mold 16 in the direction of gravity (i.e., on the side of the machine base 22 as viewed from the mold 16), and the slide device 94 is described as reciprocating the slide plate 92 along the direction of gravity. However, the direction in which the slide plate 92 reciprocates is not limited to this feature. For example, by setting the predetermined insertion starting position upwardly of the gap 80 in the direction of gravity, the slide plate 92 may be configured in a manner so as to reciprocate linearly between a location upwardly of the gap 80 and the gap 80 itself. Further, the slide plate 92 may be configured in a manner so as to reciprocate linearly along a horizontal direction (between a rearward direction and a frontward direction of the sheet surface in FIG. 1). Furthermore, as long as the device is capable of inserting and removing the slide plate 92 into and out of the gap 80, the device may insert and remove the slide plate into and from the aforementioned gap 80, by swinging the slide plate 92 like a pendulum, without linearly moving the slide plate 92.

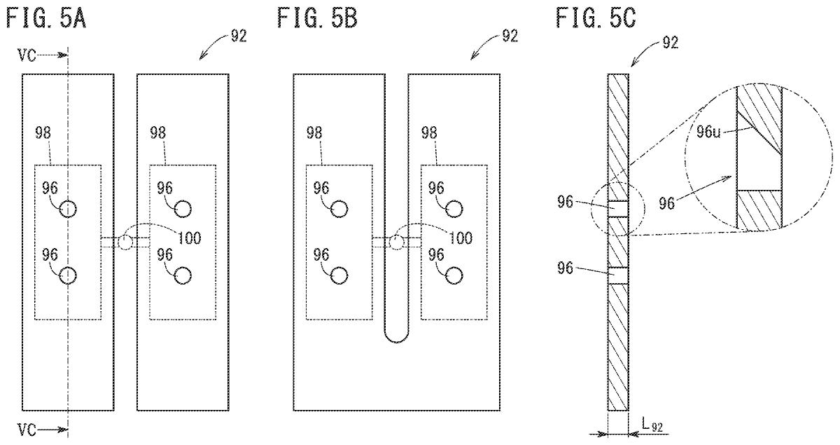

FIG. 5A shows a first exemplary configuration of a slide plate 92. It should be noted that the viewpoint of FIG. 5A is a thickness direction of the slide plate 92.

A description will further be given concerning the slide plate 92. The slide plate 92, for example, as shown in FIG. 5A, is configured as a set of a pair of plate members. Consequently, at a time when the slide plate 92 is inserted into the gap 80 between the fixed mold 62 and the fixed side mounting plate 36, a situation is prevented in which insertion thereof is obstructed by the flow path 78 (the sprue) and the resin R that has solidified into the shape of the flow path 78.

FIG. 5B shows a second exemplary configuration of the slide plate 92. In the same manner as in FIG. 5A, the viewpoint of FIG. 5B is the thickness direction of the slide plate 92.

Further, the slide plate 92 may be configured as shown in FIG. 5B. The slide plate 92 shown in FIG. 5B differs from the exemplary configuration shown in FIG. 5A, in that it is not a configuration in which two plates are provided as one set, but rather a configuration made up from one plate that is substantially U-shaped. Even with the configuration shown in FIG. 5B, at the time when the slide plate 92 is inserted into the gap 80 between the fixed mold 62 and the fixed side mounting plate 36, a situation is prevented in which insertion thereof is obstructed by the flow path 78 (the sprue) of the mold 16.

As a matter that is shared in common in the configurations shown in FIGS. 5A and 5B, second insert holes 96 are provided in the slide plate 92. The second insert holes 96 are holes that communicate with the first insert holes 68 of the fixed mold 62 in the pushing out direction when the slide plate 92 is inserted into the gap 80 between the fixed mold 62 and the fixed side mounting plate 36. Due to the second insert holes 96, even if the slide plate 92 is inserted into the gap 80, in the punching step, pushing out of the insert members 70 and the portion r of the resin R toward the fixed side mounting plate 36 by the ejector pins 88 is allowed.

Moreover, in FIG. 5A and FIG. 5B, the molded product positions 98 indicated by the dashed lines are regions arranged next to the cavity 76 (the molded product) in the pushing out direction, in a state in which the slide plate 92 has been inserted into the gap 80. Further, a runner gate member 100, which is shown by the dashed line, is a region arranged next to the runner and the gate of the flow path 78 of the mold 16 in the pushing out direction, in a state in which the slide plate 92 is inserted into the gap 80.

FIG. 5C is a cross-sectional view taken along line VC-VC of FIG. 5A.

The thickness of the slide plate 92 and the length (depth) L₉₂ of the second insert holes 96 in the pushing out direction are greater than or equal to the thickness of the resin R that is punched out in the punching step.

Further, within a side surface 96u of the second insert holes 96, a side in an insertion direction into the gap 80 is preferably of a sloped shape that narrows the width (the diameter) of the second insert holes 96 from the fixed mold 62 side toward the mounting plate 36 side when the slide plate 92 is inserted into the gap 80. For example, in the case of a configuration in which the slide plate 92 is inserted from the lower side upwardly toward the upper gap 80 as in the present embodiment, then as shown in FIG. 5C, the aforementioned sloped shape is applied to the side surface 96u on the upper side of the second insert holes 96. Moreover, in the case that such a sloped shape is applied to the second insert holes 96, the sloped shape is applied to all of the second insert holes 96 of the slide plate 92.

Consequently, at the time when the slide plate 92 is pulled out from the gap 80, the insert members 70 and the stoppers 72B that have entered into the second insert holes 96 are prevented from hindering the slide plate 92 from being pulled out. Further, due to this feature, at the same time that the slide plate 92 is pulled out, the insert members 70 can be smoothly pushed back toward the cavity 76.

The description given above concerns the overall configuration of the injection molding machine 10. Next, a description will be given of a control device 102 according to the present embodiment.

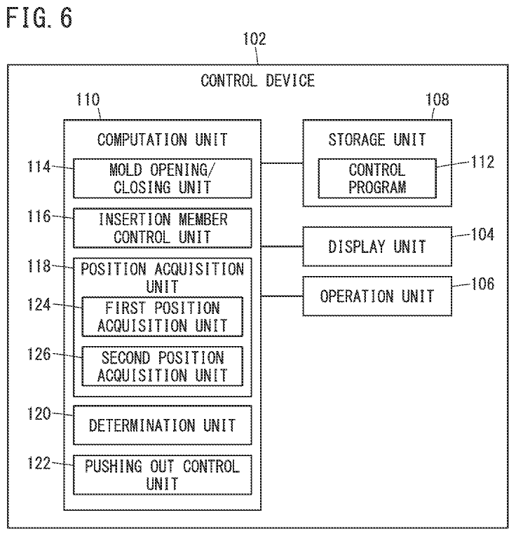

FIG. 6 is a schematic configuration diagram showing the control device 102 of the injection molding machine 10 according to the embodiment.

The control device 102 is a device that is provided in order to control the injection molding machine 10. The control device 102 is connected to and controls the injection device 12, the mold clamping device 14, the pushing out device 84, and the slide device 94 (see FIG. 1). However, in the following, descriptions concerning constituent elements that the control device 102 may be equipped with in order to control the injection device 12 will be omitted.

The control device 102 is equipped with a display unit 104, an operation unit 106, a storage unit 108, and a computation unit 110.

The display unit 104 is a display device having a screen for displaying information. Although the screen of the display unit 104 is not particularly limited, for example, the screen may be a liquid crystal screen.

The operation unit 106 is provided in order to allow an operator to input information to the control device 102, and is constituted, for example, by a keyboard, a mouse, or a touch panel that is attached to the screen of the display unit 104.

The storage unit 108 serves to store information. The storage unit 108 is constituted by hardware such as, for example, a RAM (Random Access Memory), a ROM (Read Only Memory), and the like. According to the present embodiment, a predetermined control program 112 is stored in advance in the storage unit 108.

The control program 112 is a program that defines a control method for the injection molding machine 10 (hereinafter, simply referred to as a “control method”) that carries out the punching step with high reliability. The details of such a control method will be described later.

The computation unit 110 serves to process information by carrying out computations. The computation unit 110 is constituted by hardware, for example, such as a CPU (Central Processing Unit), a GPU (Graphics Processing Unit), or the like.

Further, the computation unit 110 according to the present embodiment is equipped with a mold opening/closing unit 114, an insertion member control unit 116, a position acquisition unit 118, a determination unit 120, and a pushing out control unit 122. These units can be realized by the computation unit 110 reading in and executing the above-described control program 112.

The mold opening/closing unit 114 basically controls opening and closing of the mold 16 by controlling the mold clamping device 14. However, according to the present embodiment, creating of the gap 80 between the fixed mold 62 and the fixed side mounting plate 36 is also carried out. The mold opening/closing unit 114 controls, from the state in which the mold 16 is closed, the mold clamping device 14 to thereby cause the fixed mold 62 to move integrally with the movable mold 64 in the opening direction of the mold 16, and the gap 80 is created between the fixed mold 62 and the fixed side mounting plate 36.

The insertion member control unit 116 serves to insert the slide plate 92 into the gap 80 by controlling the slide device 94, and places the first insert holes 68 of the fixed mold 62 and the second insert holes 96 of the slide plate 92 adjacent to each other in the pushing out direction. Further, the insertion member control unit 116 also controls the slide plate 92 to be pulled out from the gap 80 after the punching pins 86 have been pushed out by a later-described punching control unit. Moreover, it is possible to determine whether or not the gap 80 has been opened, for example, by receiving a signal indicating that the gap 80 has been opened from the mold opening/closing unit 114.

The position acquisition unit 118 acquires the position of the slide plate 92 in the insertion/removal direction, and as shown in FIG. 6, according to the present embodiment, includes a first position acquisition unit 124 and a second position acquisition unit 126.

The first position acquisition unit 124 acquires the position of the slide plate 92 in the insertion direction at a time when the slide plate 92 is inserted into the gap 80. At the time when the slide plate 92 which is inserted into the gap 80 reaches the predetermined insertion determination position, the first position acquisition unit 124 outputs a predetermined detection signal (a first signal) to the later-described determination unit 120.

The second position acquisition unit 126 acquires the position of the slide plate 92 in a pulling out direction at a time when the slide plate 92 is pulled out from the gap 80. At the time when the slide plate 92 which is pulled out from the gap 80 reaches a predetermined pulled out position, the second position acquisition unit 126 outputs a predetermined detection signal (a second signal) to the later-described determination unit 120.

Moreover, in order to acquire the position of the slide plate 92, as a premise, it is necessary to detect the position of the slide plate 92. Such a feature can be realized, for example, by appropriately providing a position detector such as a linear scale or the like in the slide device 94 or in the mold 16, and providing a configuration so as to input a detection signal from such a detector to the position acquisition unit 118.

The determination unit 120 determines whether or not the slide plate 92 has been inserted into the gap 80 and whether or not the slide plate 92 has been pulled out from the gap 80. The determination unit 120 of the present embodiment determines whether or not the slide plate 92 has been inserted into the gap 80, based on whether or not the first signal is input from the first position acquisition unit 124 to the determination unit 120. Further, the determination unit 120 of the present embodiment determines whether or not the slide plate 92 has been pulled out from the gap 80, based on whether or not the second signal is input from the second position acquisition unit 126 to the determination unit 120.

In the case it is determined that the slide plate 92 has been inserted into the gap 80, the pushing out control unit 122 pushes out the punching pins 86. Consequently, according to the present embodiment, the punching step is carried out in a state in which the slide plate 92 is inserted into the gap 80. Moreover, at this time, by providing a configuration in which the cutter 90 is pushed out together with the punching pins 86, the gate cutting step can be performed in parallel with the punching step.

Further, after the punching pins 86 have been pushed out, in the case it is determined that the slide plate 92 has been pulled out from the gap 80, the pushing out control unit 122 pushes out the ejector pins 88. Consequently, the pushing out step is performed in which the molded product is taken out from the mold 16.

The above-described configuration is an exemplary configuration of the injection molding machine 10 and the control device 102 therefor according to the present embodiment. Subsequently, a description will be given concerning a control method for the injection molding machine 10 according to the present embodiment, which is executed by the control device 102.

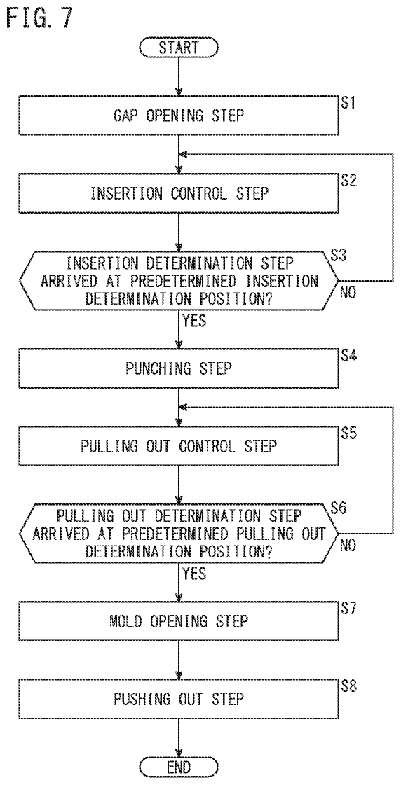

FIG. 7 is a flowchart showing an example of a control method for the injection molding machine 10 according to the embodiment.

The control method of the present embodiment is performed after the cavity 76 of the mold 16 has been filled with the resin R, in other words, after a so-called injection step has been performed. Such a control method includes a gap opening step (step S1), an insertion control step (step S2), an insertion determination step (step S3), and a punching step (step S4). Further, in the present embodiment, there are further included a pulling out control step (step S5), a pulling out determination step (step S6), a mold opening step (step S7), and a pushing out step (step S8).

FIG. 8 is a first diagram in order to describe the gap opening step. Further, FIG. 9 is a second diagram in order to describe the gap opening step. It should be noted that the viewpoint of FIGS. 8 and 9 is the same as the viewpoint of FIG. 4.

The gap opening step is a step of moving the fixed mold 62 integrally with the movable mold 64 in the opening direction of the mold 16 from the state in which the mold 16 is closed. The present step is executed by the mold opening/closing unit 114. More specifically, after the cavity 76 has been filled with the resin R (see FIG. 8), the mold opening/closing unit 114 controls the mold clamping device 14 to pull the movable platen 28 in the opening direction with a force that is less than the connection force of the parting lock 74. Consequently, the gap 80 can be created between the fixed mold 62 and the mounting plate 36 (see FIG. 9).

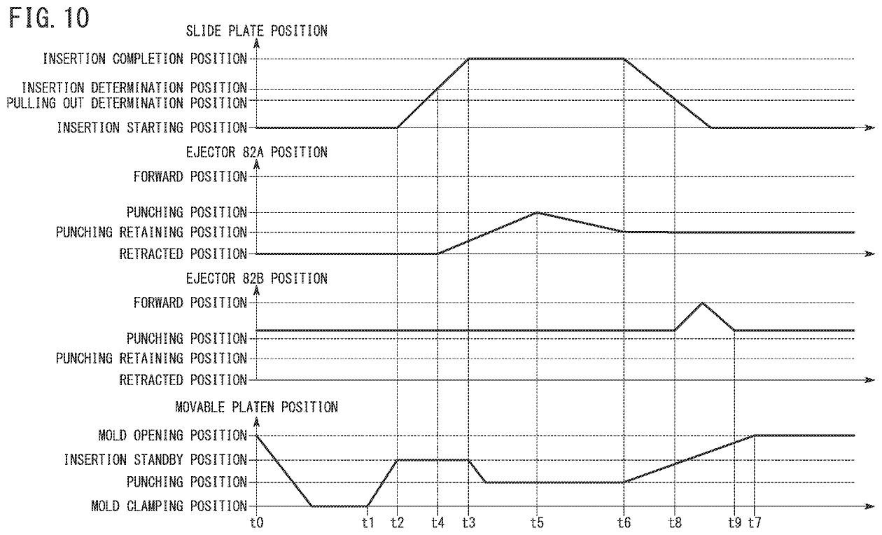

FIG. 10 is a time chart illustrating each of respective control states of the slide plate 92, the ejector plates 82A and 82B, and the movable platen 28 according to the control method.

In the time chart shown in FIG. 10, the time zone in which the gap opening step is performed is a time zone from time t₁ to time t₂. As can be seen from FIG. 10, when the gap opening step is performed, the movable platen 28 moves from the mold clamping position, which is a position in which the mold 16 is closed, to an insertion standby position. The insertion standby position is a position located closer to a side in the opening direction than the mold clamping position, and is a position in order to open the gap 80 between the fixed mold 62 and the mounting plate 36.

Further, in the time zone from time t₁ to time t₂, the positions of the ejector plates 82A and 82B are maintained at positions where neither punching nor pushing out is carried out in that time zone. In the present embodiment, this position is conveniently referred to as a retracted position. Moreover, the positions of the ejector plates 82A and 82B shown in FIG. 10 are relative positions with respect to the movable mold 64.

The insertion control step is a step of inserting the slide plate 92 into the gap 80 that is opened by executing the gap opening step. The present step is executed by the insertion member control unit 116.

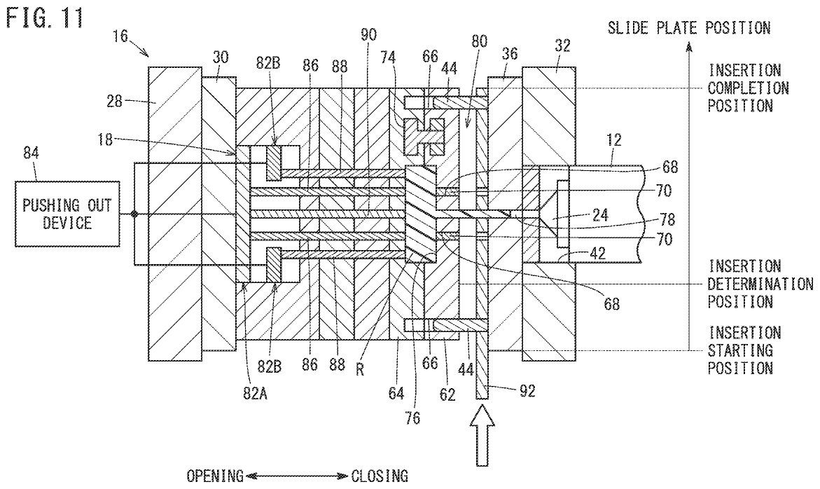

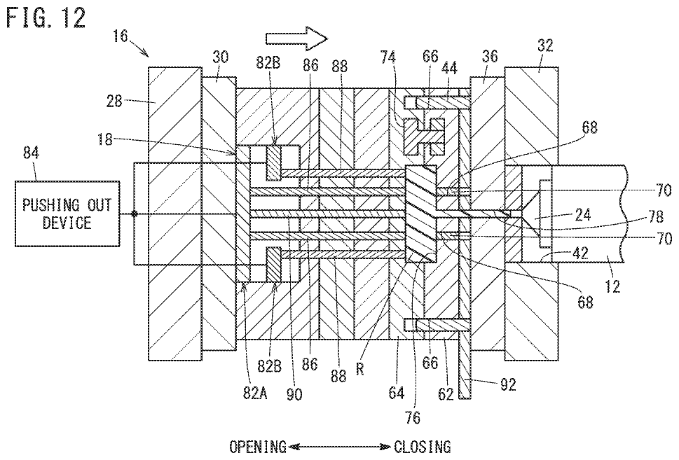

FIG. 11 is a first diagram in order to describe the insertion control step. Further, FIG. 12 is a second diagram in order to describe the insertion control step. It should be noted that the viewpoint of FIGS. 11 and 12 is the same as the viewpoint of FIG. 4.

The time zone in which the insertion control step is performed is a time zone from time t₂ to time t₃ in FIG. 10. The slide plate 92 reaches the predetermined insertion completion position by time t₃ (see FIG. 11). At this time, in the case that the gap 80 is still present between the slide plate 92 and the fixed mold 62, or alternatively, between the slide plate 92 and the mounting plate 36, then by movement of the movable platen 28 in the closing direction, the slide plate 92 is brought into intimate contact with the fixed mold 62 and the mounting plate 36 (see FIG. 12).

Further, in this time zone (time t₂ to time t₃), the insertion determination step is carried out by the determination unit 120 in parallel with the insertion control step. The insertion determination step is a step of determining whether or not the slide plate 92 has reached a predetermined insertion position. Such a determination, as noted previously, can be realized based on whether or not the first signal has been input to the determination unit 120 from the first position acquisition unit 124.

When it is determined that the slide plate 92 has reached the predetermined insertion determination position, the punching step is executed. The punching step is a step in which the aforementioned punching step is executed, and is executed by the pushing out control unit 122.

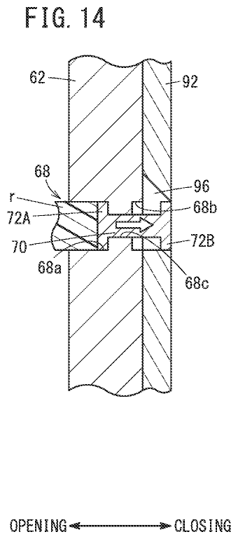

FIG. 13 is a first diagram in order to describe the punching step. FIG. 14 is a second diagram in order to describe the punching step.

The time zone in which the punching step is performed is a time zone from time t₄ to time t₅ in FIG. 10. When the punching step is executed, the ejector plate 82A moves from the aforementioned retracted position to the punching position which is located closer to a side in the pushing out direction. Consequently, the portion r of the resin R inside the cavity 76 is pushed out into the first insert holes 68, whereupon punching is completed (see FIG. 13). Further, at the same time, the cutter 90 is pushed out toward the gate, so that the gate cutting is also completed. Immediately after the completion of punching, the insert members 70 undergo sliding movement toward the second insert holes 96 of the slide plate 92 (see FIG. 14).

At a time when the punching pins 86 punch out the resin R, movement of the fixed mold 62 in the opening direction is suppressed by the movable mold 64. Further, movement in the closing direction is suppressed by the slide plate 92, which is inserted in a manner so as to fill the gap 80 between the fixed mold 62 and the mounting plate 36. Therefore, according to the present embodiment, even if the punching pins 86 punch out the resin R with a force exceeding the connection force of the parting lock 74, the mold 16 is not opened by such a force, and the connection between the movable mold 64 and the fixed mold 62 is maintained. In this manner, according to the present embodiment, it is possible to carry out the punching process with high reliability.

The punching pins 86 that have punched out the resin R are temporarily retracted to a position (a punching retaining position) that does not obstruct pulling out of the slide plate 92 in a subsequent time zone from time t₅ to time t₆.

Moreover, as can be understood with reference to FIG. 10, the punching step can be initiated before the slide plate 92 arrives at the predetermined insertion completion position. This feature can be realized by adjusting a balance between the speed at which the ejector plate 82A is moved in the pushing out direction and the speed at which the slide plate 92 is inserted such that the punching can be performed substantially at the same time as the slide plate 92 arrives at the predetermined insertion completion position.

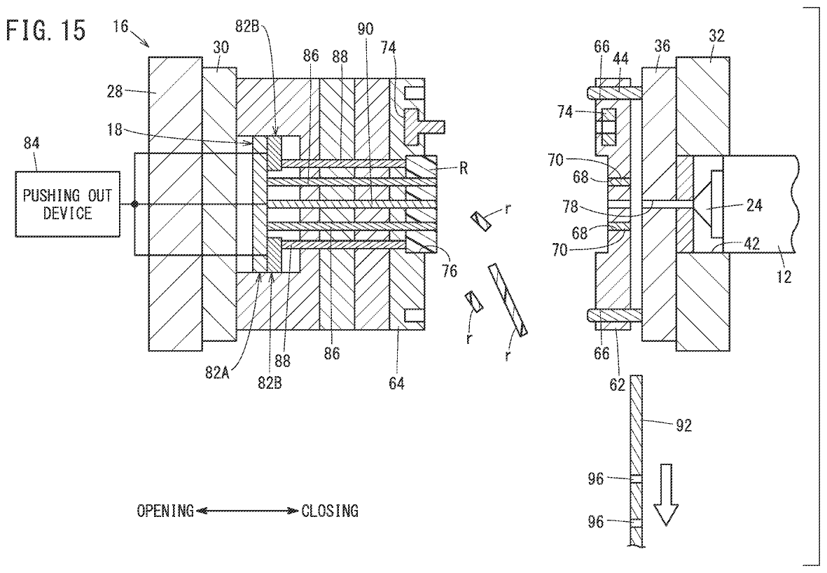

FIG. 15 is a first diagram in order to describe the mold opening step and the pulling out control step.

The mold opening step is a step of opening the mold 16. The present step is executed by the mold opening/closing unit 114. More specifically, the mold opening/closing unit 114 controls the mold clamping device 14 in the time zone from time t₆ to time t₇ in FIG. 10, and thereby pulls the movable platen 28 in the opening direction with a force that is greater than the connection force of the parting lock 74. Consequently, the movable platen 28 moves to the mold opening position (see FIG. 10) at which the mold 16 is opened, and the mold 16 itself is opened.

The pulling out control step is a step of pulling out the slide plate 92 from the gap 80 after completion of the punching step. The present step is executed by the insertion member control unit 116. The pulling out control step can be performed in parallel with the mold opening step (see FIG. 10).

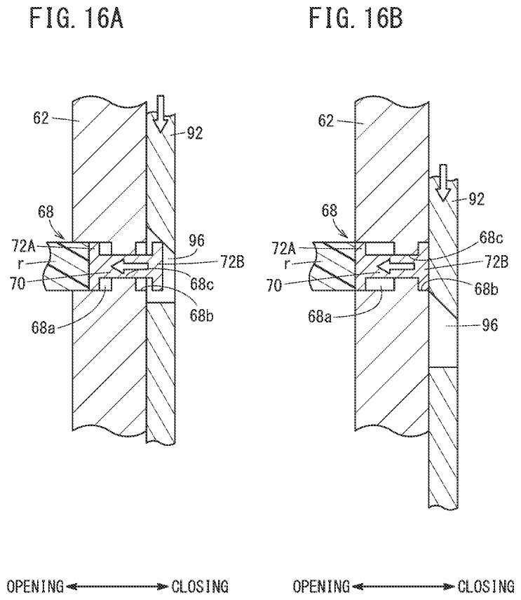

FIG. 16A is a second diagram in order to describe the mold opening step and the pulling out control step. FIG. 16B is a third diagram in order to describe the mold opening step and the pulling out control step. The viewpoint of either of these figures is the same as the viewpoint of FIG. 3.

In the pulling out control step, the slide plate 92 is slid in the pulling out direction. At this time, due to the aforementioned sloped shape of the second insert holes 96, the insert members 70 are pushed back toward the fixed mold 62 accompanying sliding of the slide plate 92 in the pulling out direction (see FIG. 16B). In addition, by further pulling out the slide plate 92, it is possible for the insert members to exit from the second insert holes 96 and to return to the state shown in FIG. 3.

Furthermore, in the time zone (from time t₆ to time t₇) when the mold opening step and the pulling out control step are performed, the pulling out determination step is also carried out by the determination unit 120. The pulling out determination step is a step of determining whether or not the slide plate 92 has reached a predetermined pulling out determination position. Such a determination, as noted previously, can be realized based on whether or not the second signal has been input to the determination unit 120 from the second position acquisition unit 126.

FIG. 17 is a diagram in order to describe the pushing out step.

When it is determined that the slide plate 92 has reached the predetermined pulling out determination position, the pushing out step is executed. The pushing out step is a step in which the aforementioned pushing out step is executed, and in the same manner as the punching step, is executed by the pushing out control unit 122. By performing the pushing out step, the molded product can be easily taken out from the mold 16 (see FIG. 17).

The time zone in which the pushing out step is performed is a time zone from time t₈ to time t₉ in FIG. 10. As can be understood with reference to FIG. 10, the pushing out step can be initiated before the slide plate 92 arrives at the predetermined pulling out completion position (the insertion starting position), and before the movable platen 28 arrives at the mold opening position. Such a feature is realized by adjusting a balance between the speed at which the ejector plate 82B is moved in the pushing out direction and the speed at which the slide plate 92 is pulled out. More specifically, such a feature can be realized by allowing the mold opening to be completed and the molded product to be pushed out substantially at the same time as the slide plate 92 arrives at the predetermined pushing out completion position. However, the pushing out step may also be initiated after the mold 16 has been opened, in other words, after time t₇ at which the movable platen 28 in FIG. 10 has arrived at the mold opening position.

According to the above-described control method, it is possible to carry out the punching step with high reliability. Further, after the pushing out step has been completed, by closing the mold 16, the cavity 76 can be filled again with the resin R. In other words, the aforementioned control method can be applied as a portion of a so-called molding cycle, and the control device 102 that executes such a control method contributes to efficient mass production of high-quality molded products.

### Modifications

The embodiment has been described above as one example of the present invention. It goes without saying that various modifications or improvements are capable of being added to the above-described embodiment. Further, it is clear from the scope of the claims that other modes to which such modifications or improvements have been added can be included within the technical scope of the present invention.

### Exemplary Modification 1

In the embodiment, a configuration has been described in which the determination unit 120 determines whether or not the slide plate 92 has been inserted into the gap 80 on the basis of the position of the slide plate 92 acquired by the first position acquisition unit 124. However, the configuration of the control device 102 is not necessarily limited to this feature.

For example, if the insertion speed of the slide plate 92 with respect to the gap 80 is known, based on an elapsed time period from the start of insertion of the slide plate 92, it is possible to determine whether or not insertion thereof has been completed. More specifically, the insertion member control unit 116 of the control device 102 may insert the slide member into the gap 80 at the first speed. In addition, in that case, the determination unit 120 may determine whether or not the slide plate 92 has been inserted, based on whether or not the first predetermined time period has elapsed from after insertion of the slide plate 92 has started. Moreover, measurement of the elapsed time period can be easily achieved by realizing a timer function by the computation unit 110.

In accordance with these features, as in the embodiment, the control device 102 and the control method for the injection molding machine 10 are provided, which carry out the punching step with high reliability. Further, in the case of the configuration of the present exemplary modification, the first position acquisition unit 124 can be omitted from the configuration of the control device 102.

### Exemplary Modification 2

In the embodiment, a configuration has been described in which the determination unit 120 determines whether or not the slide plate 92 has been pulled out from the gap 80 on the basis of the position of the slide plate 92 acquired by the second position acquisition unit 126. However, the configuration of the control device 102 is not necessarily limited to this feature.

For example, if the pulling out speed of the slide plate 92 with respect to the gap 80 is known, then based on an elapsed time period from the start of pulling out of the slide plate 92, it is possible to determine whether or not pulling out thereof has been completed. More specifically, the insertion member control unit 116 of the control device 102 may pull out the slide member from the gap 80 at the second speed. In addition, in that case, the determination unit 120 may determine whether or not the slide plate 92 has been pulled out, based on whether or not the second predetermined time period has elapsed from after pulling out of the slide plate 92 has started. Moreover, in the same manner as in Exemplary Modification 1, measurement of the elapsed time period can be easily achieved by realizing a timer function by the computation unit 110.

In accordance with these features, as in the embodiment, the control device 102 and the control method for the injection molding machine 10 are provided, which carry out the punching step with high reliability. Further, in the case of the configuration of the present exemplary modification, the second position acquisition unit 126 can be omitted from the configuration of the control device 102.

### Exemplary Modification 3

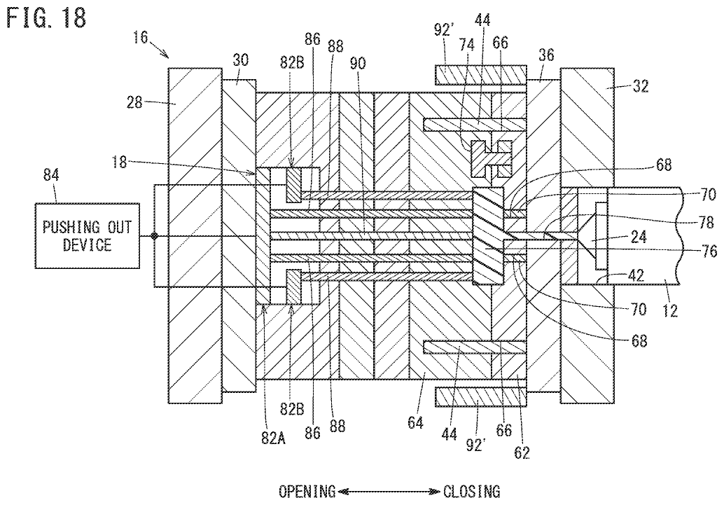

FIG. 18 is a configuration diagram in order to describe the insertion member 92′ according to an Exemplary Modification 3.

The insertion member 92 is not limited to being the slide plate in which the second insert holes 96 are formed. An example thereof is illustrated in FIG. 18. Moreover, for the sake of convenience, the insertion member 92 of the present modification may also be referred to as an insertion member 92′.

The illustrated insertion member 92′ is a circular cylindrical or rectangular cylindrical member having a longitudinal direction in the opening/closing direction, and is inserted into the gap 80 in manner so as not to be adjacent to the first insert holes 68 in the opening/closing direction. According to the present exemplary modification, as shown in FIG. 18, two of the insertion members 92′ are prepared, and the insertion members are inserted respectively on one side (an upper side) and the other side (a lower side) in the direction of gravity with respect to the first insert holes 68. In accordance with these features, the pressing force from the fixed mold 62 and the mounting plate 36 at the time when they are inserted into the gap 80 becomes distributed to each of the two insertion members 92′, and it is possible to reduce any concern that the insertion members 92′ will become distorted by the pressing force.

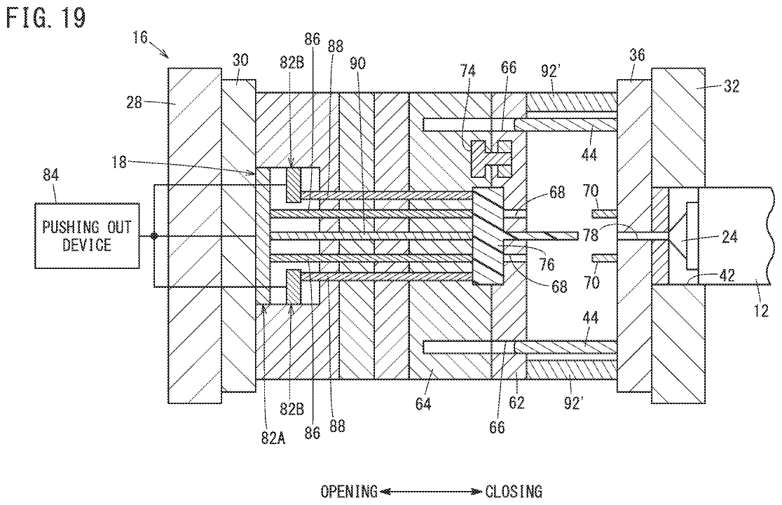

FIG. 19 is a diagram showing a state in which the insertion members 92′ according to Exemplary Modification 3 are inserted into the gap 80.

According to the present exemplary modification, unlike the embodiment, due to insertion of the insertion members 92′ therein, the gap 80 is prevented from being filled. Moreover, according to the present modification, the insert members 70 are provided on the mounting plate 36. Further, the central portions 68c of the first insert holes 68 illustrated in FIG. 3 are of the same width as the opening direction side 68a in the present modification, and allow the insert members 70 to be inserted into and removed from the first insert holes 68. Accordingly, while the insertion members 92′ are inserted into the gap 80, the first insert holes 68 are maintained in a state of communication with the gap 80.

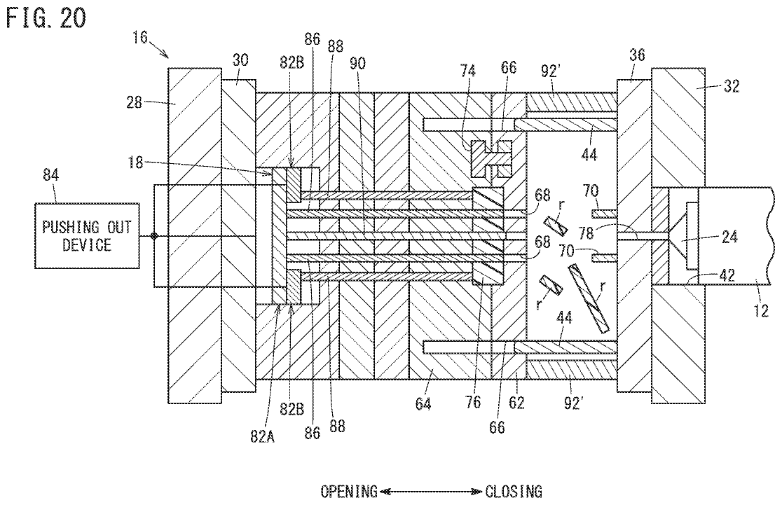

FIG. 20 is a diagram in order to describe the punching step according to Exemplary Modification 3.

In FIG. 20, a state is illustrated in which the punching pins 86 are pushed out with the insertion members 92′ being inserted into the gap 80. In the same manner as in the embodiment, when the punching pins 86 are pushed out, movement of the fixed mold 62 in the opening direction is suppressed by the movable mold 64, and movement in the closing direction is suppressed by the insertion members 92′. Therefore, in the present exemplary modification also, it is possible to carry out the punching process with high reliability.

In this manner, even by means of the insertion members 92′ in which the second insert holes 96 are not formed, it is possible to perform the punching process with high reliability. The punched out portion r of the resin R is discharged when the mold is opened.

Moreover, although the insertion members 92′ illustrated in FIG. 18 are cylindrical or columnar members having a longitudinal direction in the opening/closing direction, the configuration of the insertion members 92′ is not necessarily limited to this feature. The insertion members 92′, for example, may be block-shaped members or plate-shaped members.

Further, in FIG. 19, although the insertion members 92′ are inserted along the direction of gravity from the state shown in FIG. 18, in the same manner as in the insertion member 92 of the embodiment, the sliding direction in which the insertion members 92′ are inserted and removed is not limited to the direction of gravity.

Further, although FIG. 18 illustrates a configuration in which two of the insertion members 92′ are provided, the configuration of the present exemplary modification is not necessarily limited to this feature. For example, a tubular member having an opening that penetrates therethrough in the opening/closing direction may be inserted into and removed from the gap 80.

### Exemplary Modification 4

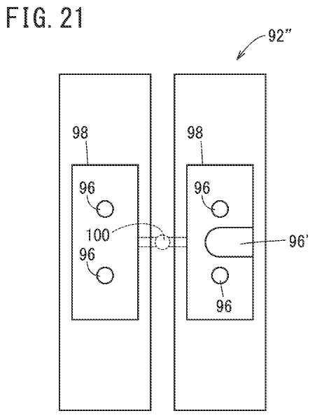

FIG. 21 is a fourth exemplary configuration of the slide plate 92. Hereinafter, for the sake of convenience, the slide plate 92 in FIG. 21 may also be referred to as a slide plate 92″.

Although in the embodiment, a description has been given of the configuration of the injection molding machine 10 for forming the hole in a molded product, the embodiment can also be applied to a case of forming a notch or cutout portion in the molded product. In that case, as shown in FIG. 21, a second insert hole 96 (hereinafter, referred to as a “second insert hole 96′”) in order to form a notch in the molded product is provided in the slide plate 92″. In the punching step, it is possible to form the notch in the molded product by pushing out the punching pin 86 toward the second insert hole 96′.

Moreover, the configuration of the slide plate 92″ is not limited to the configuration illustrated by way of example in FIG. 21. More specifically, in the slide plate 92″, as shown in FIG. 21, both types or only one type of the second insert hole 96 in order to form the holes in the molded product and the second insert hole 96 (96′) in order to form the notch in the molded product may be provided.

### Modification 5

The embodiments and the exemplary modifications thereof may be appropriately combined within a range in which no technical inconsistencies occur.

### Inventions that can be Obtained from the Embodiment

The inventions that can be grasped from the above-described embodiment and the modifications thereof will be described below.

### First Invention

In the control device (102) for the injection molding machine (10), the injection molding machine including a mold (16), the mold including the fixed mold (62) in which the first insert hole (68) is provided and the movable mold (64) that forms the cavity (76) together with the fixed mold (62), the mold (16) being configured to be opened and closed by causing the fixed mold (62) and the movable mold (64) to separate away from and come into contact with each other, the injection molding machine (10) further includes the movable platen (28) that supports the movable mold (64) and that moves along the opening/closing direction of the mold (16) to thereby cause the movable mold (64) to separate away from and come into contact with the fixed mold (62), the stationary platen (32) that supports the fixed mold (62), the parting lock (74) that connects the fixed mold (62) and the movable mold (64) at a time when the movable platen (28) moves in the closing direction of the mold (16), and that releases the connection at a time when the mold (16) is opened, the mounting plate (36) that mounts the fixed mold (62) on the stationary platen (32), the punching pin (86) which, in order to form a molded product including at least one of a hole or a cutout portion therein, projects out in a manner so as to punch out a portion (r) of the resin (R) inside the cavity (76) toward the mounting plate (36) via the first insert hole (68), and the insertion member (92) configured to be inserted between the fixed mold (62) and the mounting plate (36), and the control device (102) includes the mold opening/closing unit (114) which, by causing the fixed mold (62) to move in an integral manner with the movable mold (64) in the opening direction of the mold (16) from a state in which the mold (16) is closed, creates the gap (80) between the fixed mold (62) and the mounting plate (36), the insertion member control unit (116) that inserts the insertion member (92) into the gap (80), the determination unit (120) that determines whether or not the insertion member (92) has been inserted into the gap (80), and the pushing out control unit (122) that pushes out the punching pin (86) in the case that it is determined that the insertion member (92) has been inserted into the gap (80).

In accordance with these features, the control device (102) for the injection molding machine (10) is provided, which carries out the punching step with high reliability.

The insertion member control unit (116) may insert the insertion member into the gap (80) at the first speed, and the determination unit (120) may determine whether or not the insertion member (92) has been inserted based on whether or not the first predetermined time period has elapsed after insertion of the insertion member (92) has started. In accordance with these features, the first position acquisition unit (124) can be omitted from the configuration of the control device (102).

There may further be provided the first position acquisition unit (124) that acquires the position of the insertion member (92) in the insertion direction, and the determination unit (120) may determine whether or not the insertion member (92) has been inserted based on the position of the insertion member (92) acquired by the first position acquisition unit (124). In accordance with these features, it can be easily grasped that the insertion member (92) has arrived at the predetermined insertion determination position.

After the punching pin (86) has been pushed out, the insertion member control unit (116) may pull out the insertion member (92) from the gap (80), and after pulling out of the insertion member (92) has started, the mold opening/closing unit (114) may open the mold (16) by separating the movable mold (64) away from the fixed mold (62). In accordance with these features, it becomes possible to take out the molded product from the mold (16).

The injection molding machine (10) may further include the ejector pin (88) that pushes out the molded product and takes out the molded product from the mold (16), after pulling out of the insertion member (92) has started, the determination unit (120) may further determine whether or not the insertion member (92) has been pulled out from the gap (80), and in the case that it is determined that the insertion member (92) has been pulled out from the gap (80), the pushing out control unit (122) may take out the molded product from the mold (16) by pushing out the ejector pin (88). In accordance with these features, it becomes possible to easily take out the molded product.

The insertion member control unit (116) may pull out the insertion member from the gap (80) at the second speed, and the determination unit (120) may determine whether or not the insertion member (92) has been pulled out based on whether or not the second predetermined time period has elapsed after pulling out of the insertion member (92) has started. In accordance with these features, the second position acquisition unit (126) can be omitted from the configuration of the control device (102).

There may further be provided the second position acquisition unit (126) that acquires the position of the insertion member (92) in the pulling out direction, and the determination unit (120) may determine whether or not the insertion member (92) has been pulled out based on the position of the insertion member (92) acquired by the second position acquisition unit (126). In accordance with these features, it can be easily grasped that the insertion member (92) has arrived at the predetermined pulling out determination position.

The injection molding machine (10) may further include the cutter (90) that cuts off the gate of the mold (16), and in the case it is determined that the insertion member (92) has been inserted into the gap (80), the pushing out control unit (122) may perform gate cutting by pushing out the cutter (90) together with the punching pin (86). In accordance with these features, it becomes possible to efficiently perform gate cutting.

The fixed mold (62) may further include the insert member (70) configured to be inserted into the first insert hole (68), the insertion member (92) may be a plate-shaped member having a second insert hole (96) that allows the insert member (70) and the portion (r) of the resin (R) to be pushed out toward the mounting plate (36) by the punching pin (86), and by the insertion member (92) being inserted into the gap (80), the insertion member control unit (116) may place the first insert hole (68) of the fixed mold (62) and the second insert hole (96) of the insertion member (92) adjacent to each other in the pushing out direction of the punching pin (86). In accordance with these features, even if the gap (80) does not exist between the fixed mold (62) and the insertion member (92) in the opening/closing direction, since the insert member (70) can be moved inside the second insert hole (96) during the punching step, it becomes possible to perform the punching step.

### Second Invention

In the control method for the injection molding machine (10), the injection molding machine including the mold (16), the mold including the fixed mold (62) in which the first insert hole (68) is provided and the movable mold (64) that forms the cavity (76) together with the fixed mold (62), the mold (16) being configured to be opened and closed by causing the fixed mold (62) and the movable mold (64) to separate away from and come into contact with each other, the injection molding machine (10) further includes the movable platen (28) that supports the movable mold (64), and which moves along the opening/closing direction of the mold (16) and thereby cause the movable mold (64) to separate away from and come into contact with the fixed mold (62), the stationary platen (32) that supports the fixed mold (62), the parting lock (74) that connects the fixed mold (62) and the movable mold (64) at a time when the movable platen (28) moves in the closing direction of the mold (16), and which releases the connection at a time when the mold (16) is opened, the mounting plate (36) that mounts the fixed mold (62) on the stationary platen (32), the punching pin (86) which, in order to form a molded product including at least one of a hole or a cutout portion therein, projects out in a manner so as to punch out a portion (r) of the resin (R) inside the cavity (76) toward the mounting plate (36) via the first insert hole (68), and the insertion member (92) configured to be inserted between the fixed mold (62) and the mounting plate (36), and the control method includes the gap opening step of creating the gap (80) between the fixed mold (62) and the mounting plate (36), by causing the fixed mold (62) to move in an integral manner with the movable mold (64) in the opening direction of the mold (16) from a state in which the mold (16) is closed, the insertion control step of inserting the insertion member (92) into the gap (80), the insertion determination step of determining whether or not the insertion member (92) has been inserted into the gap (80), and the punching step of pushing out the punching pin (86) in the case that it is determined that the insertion member (92) has been inserted into the gap (80).

In accordance with these features, the control method for the injection molding machine (10) is provided, which carries out the punching step with high reliability.

1. A control device for an injection molding machine, the injection molding machine comprising a mold, the mold including a fixed mold in which a first insert hole is provided and a movable mold configured to form a cavity together with the fixed mold, the mold being configured to be opened and closed by causing the fixed mold and the movable mold to separate away from and come into contact with each other;
wherein the injection molding machine further comprises:
a movable platen configured to support the movable mold, and configured to move along an opening/closing direction of the mold and thereby cause the movable mold to separate away from and come into contact with the fixed mold;
a stationary platen configured to support the fixed mold;
a parting lock configured to connect the fixed mold and the movable mold at a time when the movable platen moves in a closing direction of the mold, and to release the connection at a time when the mold is opened;
a mounting plate configured to mount the fixed mold on the stationary platen;
a punching pin that, in order to form a molded product including at least one of a hole or a cutout portion therein, is configured to be pushed out in a manner so as to punch out a portion of a resin inside the cavity toward the mounting plate via the first insert hole; and
an insertion member configured to be inserted between the fixed mold and the mounting plate; and
wherein the control device comprises:
a mold opening/closing unit that, by causing the fixed mold to move integrally with the movable mold in an opening direction of the mold from a state in which the mold is closed, is configured to create a gap between the fixed mold and the mounting plate;
an insertion member control unit configured to insert the insertion member into the gap;
a determination unit configured to determine whether or not the insertion member has been inserted into the gap; and
a pushing out control unit configured to push out the punching pin in a case that it is determined that the insertion member has been inserted into the gap.

2. The control device for the injection molding machine according to claim 1, wherein:
the insertion member control unit inserts the insertion member into the gap at a first speed; and
the determination unit determines whether or not the insertion member has been inserted based on whether or not a first predetermined time period has elapsed after insertion of the insertion member has started.

3. The control device for the injection molding machine according to claim 1, further comprising:
a first position acquisition unit configured to acquire a position of the insertion member in an insertion direction;
wherein the determination unit determines whether or not the insertion member has been inserted based on the position of the insertion member acquired by the first position acquisition unit.

4. The control device for the injection molding machine according to claim 1, wherein:
the insertion member control unit pulls out the insertion member from the gap after the punching pin has been pushed out; and
after pulling out of the insertion member has started, the mold opening/closing unit opens the mold by separating the movable mold away from the fixed mold.

5. The control device for the injection molding machine according to claim 4, wherein:
the injection molding machine further comprises an ejector pin configured to push out the molded product and take out the molded product from the mold;
after pulling out of the insertion member has started, the determination unit further determines whether or not the insertion member has been pulled out from the gap; and
in a case that it is determined that the insertion member has been pulled out from the gap, the pushing out control unit takes out the molded product from the mold by pushing out the ejector pin.

6. The control device for the injection molding machine according to claim 5, wherein:
the insertion member control unit pulls out the insertion member from the gap at a second speed; and
the determination unit determines whether or not the insertion member has been pulled out based on whether or not a second predetermined time period has elapsed after pulling out of the insertion member has started.

7. The control device for the injection molding machine according to claim 5, further comprising:
a second position acquisition unit configured to acquire a position of the insertion member in a pulling out direction;
wherein the determination unit determines whether or not the insertion member has been pulled out based on the position of the insertion member acquired by the second position acquisition unit.

8. The control device for the injection molding machine according to claim 1, wherein:
the injection molding machine further comprises a cutter configured to cut off a gate of the mold; and
in a case it is determined that the insertion member has been inserted into the gap, the pushing out control unit performs gate cutting by pushing out the cutter together with the punching pin.

9. The control device for the injection molding machine according to claim 1, wherein:
the fixed mold further comprises an insert member configured to be inserted into the first insert hole;
the insertion member is a plate-shaped member having a second insert hole configured to allow the insert member and the portion of the resin to be pushed out toward the mounting plate by the punching pin; and
by the insertion member being inserted into the gap, the insertion member control unit places the first insert hole of the fixed mold and the second insert hole of the insertion member adjacent to each other in a pushing out direction of the punching pin.

10. A control method for an injection molding machine, the injection molding machine comprising a mold, the mold including a fixed mold in which a first insert hole is provided and a movable mold configured to form a cavity together with the fixed mold, the mold being configured to be opened and closed by causing the fixed mold and the movable mold to separate away from and come into contact with each other;
wherein the injection molding machine further comprises:
a movable platen configured to support the movable mold, and configured to move along an opening/closing direction of the mold and thereby cause the movable mold to separate away from and come into contact with the fixed mold;
a stationary platen configured to support the fixed mold;
a parting lock configured to connect the fixed mold and the movable mold at a time when the movable platen moves in a closing direction of the mold, and to release the connection at a time when the mold is opened;
a mounting plate configured to mount the fixed mold on the stationary platen;
a punching pin that, in order to form a molded product including at least one of a hole or a cutout portion therein, is configured to be pushed out in a manner so as to punch out a portion of a resin inside the cavity toward the mounting plate via the first insert hole; and
an insertion member configured to be inserted between the fixed mold and the mounting plate; and
wherein the control method comprises:
a gap opening step of creating a gap between the fixed mold and the mounting plate, by causing the fixed mold to move integrally with the movable mold in an opening direction of the mold from a state in which the mold is closed;
an insertion control step of inserting the insertion member into the gap;
an insertion determination step of determining whether or not the insertion member has been inserted into the gap; and
a punching step of pushing out the punching pin in a case that it is determined that the insertion member has been inserted into the gap.
